(19) United States
(12) Patent Application Publication
(10) Pub. No.: US 2023/0303269 A1
(43) Pub. Date: Sep. 28, 2023

(54) HEAT REJECTION BASED ON DYNAMIC CONTROL OVER A RANGE OF ALTITUDES

(71) Applicant: Hamilton Sundstrand Space Systems International, Inc., Windsor Locks, CT (US)

(72) Inventors: Ashley Himmelmann, Hartford, CT (US); Diego S. Mugurusa, North Haven, CT (US)

(21) Appl. No.: 17/713,737

(22) Filed: Apr. 5, 2022

Related U.S. Application Data
(60) Provisional application No. 63/324,287, filed on Mar. 28, 2022.

(51) Int. Cl. B64G 1/50

(52) U.S. Cl. CPC B64G 1/50

(57) ABSTRACT

A heat rejection system in a vehicle includes a heat exchanger to take in input coolant and to output a warmed coolant, a heat of vaporization device (HVD), and a heat of fusion device (HFD). The heat rejection system also includes a controller to direct the warmed coolant to the HVD or to the HFD based on an input. The input indicates altitude of the vehicle or ambient pressure.

### CROSS-REFERENCE TO RELATED APPLICATIONS

This application claims the benefit of U.S. Provisional Application No. 63/324,287 filed Mar. 28, 2022, the disclosure of which is incorporated herein by reference in its entirety.

### BACKGROUND

Exemplary embodiments pertain to the art of vehicle cabin air temperature control and, in particular, to heat rejection based on dynamic control over a range of altitudes.

Air temperature control is an important function in many environments (e.g., homes, businesses, vehicles) and often requires connection to a coolant loop heat sink. In an aircraft or space vehicle, the available means of heat rejection for the coolant loop is affected by different ambient environmental variations and other vehicle constraints (e.g., power consumption, mass, and volume). In a spacecraft, for example, external absolute pressure may change from approximately 14.7 pounds per square inch (psia) on earth to near vacuum in space. The variations create challenges for controlling a coolant temperature in a heat exchanger that provides the cabin air.

### BRIEF DESCRIPTION

In one exemplary embodiment, a heat rejection system in a vehicle includes a heat exchanger to take in input coolant and to output a warmed coolant, a heat of vaporization device (HVD), and a heat of fusion device (HFD). The heat rejection system also includes a controller to direct the warmed coolant to the HVD or to the HFD based on an input, wherein the input indicates altitude of the vehicle or ambient pressure.

In addition to one or more of the features described herein, the heat rejection system also includes a first valve and a second valve. The controller controls the first valve to direct a flow of the warmed coolant to the HVD or to the second valve and to control the second valve to direct a flow of the warmed coolant or a flow of an output of the HVD to the HFD or to direct the flow of the output of the HVD to the heat exchanger as the input coolant.

In addition to one or more of the features described herein, the warmed coolant is water.

In addition to one or more of the features described herein, the HVD is a water membrane evaporator (WME).

In addition to one or more of the features described herein, the WME includes a hydrophobic membrane through which the water flows and evaporation of the water at a surface of the hydrophobic membrane results in heat rejection.

In addition to one or more of the features described herein, the HFD is a water and ice heat exchanger (WIHX).

In addition to one or more of the features described herein, the water interacts with ice in the WIHX and heat rejection results in melting of the ice.

In addition to one or more of the features described herein, the heat rejection system also includes a filter at an output of the WIHX to prevent ice from exiting the WIHX.

In addition to one or more of the features described herein, the heat rejection system also includes a pump disposed between the heat exchanger and the first valve.

In addition to one or more of the features described herein, the vehicle is a spacecraft.

In another exemplary embodiment, a method of assembling a heat rejection system for a vehicle includes arranging a heat exchanger configured to take in input coolant and to output a warmed coolant. The method also includes assembling a heat of vaporization device (HVD), assembling a heat of fusion device (HFD), and configuring a controller to direct the warmed coolant to the HVD or to the HFD based on an input. The input indicates altitude of the vehicle or ambient pressure.

In addition to one or more of the features described herein, the method also includes arranging a first valve and a second valve. The configuring the controller includes the controller controlling the first valve to direct a flow of the warmed coolant to the HVD or to the second valve and controlling the second valve to direct a flow of the warmed coolant or a flow of an output of the HVD to the HFD or to direct the flow of the output of the HVD to the heat exchanger as the input coolant.

In addition to one or more of the features described herein, the warmed coolant is water.

In addition to one or more of the features described herein, the assembling the HVD includes assembling a water membrane evaporator (WME).

In addition to one or more of the features described herein, the assembling the WME includes arranging a hydrophobic membrane through which the water flows and evaporation of the water at a surface of the hydrophobic membrane results in heat rejection.

In addition to one or more of the features described herein, the assembling the HFD includes assembling a water and ice heat exchanger (WIHX).

In addition to one or more of the features described herein, the assembling the WIHX includes filling the WIHX with ice such that water interacts with ice in the WIHX and heat rejection results in melting of the ice.

In addition to one or more of the features described herein, the method also includes arranging a filter at an output of the WIHX to prevent ice from exiting the WIHX.

In addition to one or more of the features described herein, the method also includes disposing a pump between the heat exchanger and the first valve.

In addition to one or more of the features described herein, the vehicle is a spacecraft.

### BRIEF DESCRIPTION OF THE DRAWINGS

The following descriptions should not be considered limiting in any way. With reference to the accompanying drawings, like elements are numbered alike:

FIG. 1 is a block diagram of a heat rejection system according to one or more embodiments;

FIG. 2 is a block diagram of a heat rejection system with a pressurized accumulator according to one or more embodiments; and

FIG. 3 is a process flow of a method of performing heat rejection according to one or more embodiments.

### DETAILED DESCRIPTION

A detailed description of one or more embodiments of the disclosed apparatus and method are presented herein by way of exemplification and not limitation with reference to the Figures.

Embodiments of the systems and methods detailed herein relate to heat rejection based on dynamic control over a range of altitudes. A cabin air heat exchanger may be used to cool air for reuse in a vehicle cabin. The heat rejection detailed herein is for the coolant supplied to the cabin air heat exchanger. For explanatory purposes, water is assumed as the exemplary coolant for which heat rejection is implemented. However, any coolant material may be used if it is selected with consideration of the pressure differences discussed herein. Heat is rejected via vaporization and/or via fusion based on dynamic control according to the altitude of the vehicle and the associated absolute ambient pressure (i.e., pressure of the external environment).

As detailed, at lower altitudes (e.g., on the earth's surface with an absolute ambient pressure around 14.7 psia), heat may be rejected from the coolant only via fusion. At very high altitudes (e.g., in space with a near 0 psia), heat may sufficiently also be rejected via vaporization. At altitudes between earth and space, heat rejection via vaporization may not cool the coolant sufficiently such that both vaporization and fusion are implemented. By using fusion, vaporization, or a combination of the two based on altitude (and corresponding external pressure), the coolant (e.g., water) that is lost to the vaporization may be replenished with melted ice resulting from the fusion. Overall, the heat rejection process according to one or more embodiments benefits from requiring less replenishment (and, thus, transport) of coolant.

In the exemplary case of the coolant being water, heat rejection via vaporization (i.e., with a heat of vaporization device (HVD)) may be accomplished via a water membrane evaporator (WME) and heat rejection via fusion (i.e., with a heat of fusion device (HFD)) may be accomplished via a water/ice heat exchanger (WIHX). Unlike prior WIHX devices, the coolant (e.g., water) is not routed through the ice while being kept separated from the ice via piping. Instead, according to one or more embodiments, the water used as the coolant interacts with the ice such that any water that results from the ice melting is added to the coolant loop. In this way, replenishment of water lost in the WME as vapor via vaporization may be needed less frequently, thereby reducing the amount and weight of water or ice that must be carried in the vehicle. The WIHX may also act as an accumulator for the coolant system. Thus, as previously noted, using both the WME and the WIHX reduces the need for replenishment of the coolant, which must be transported in the vehicle.

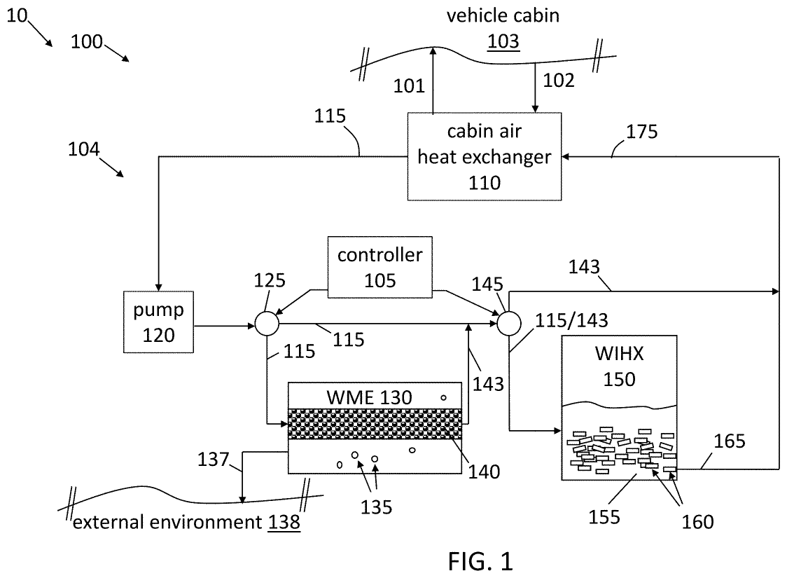

FIG. 1 is a block diagram of a heat rejection system 100 in a vehicle 10 according to one or more embodiments. As previously noted, the heat rejection system 100 may be used with a cabin air heat exchanger 110, as shown. Generally, warm cabin air 102 and input coolant 175 interact in the cabin air heat exchanger 110. The result is cool cabin air 101 that is provided to the vehicle cabin 103 and warmed coolant 115 that must be cooled in a coolant loop 104. Heat rejection is implemented in the coolant loop 104 by the heat rejection system 100 to cool down the warmed coolant 115 and produce input coolant 175. As previously noted, the specific heat rejection that is implemented may be altitude specific and may be controlled by the controller 105. As also noted, as altitude increases, ambient pressure (pressure of the external environment 138) decreases.

The warmed coolant 115 is provided to a pump 120 that keeps the coolant moving through the coolant loop 104. The controller 105 controls two controlled valves 125 and 145 to determine whether the WME 130 and the WIHX 150 participate in the heat rejection. The controller 105 controls the two controlled valves 125, 145 based on altitude and a corresponding ambient pressure (i.e., pressure of the external environment 138). This control is summarized in Table 1, which indicates the input to the WME 130 and to the WIHX 150 at different altitudes/pressure differences.

A scenario involving a relatively low altitude (i.e., a relatively high ambient pressure and a relatively low corresponding pressure difference) is discussed first. This scenario may occur on the earth's surface, for example, where the absolute ambient pressure is about 14.7 psia. In this case, as Table 1 indicates, none of the warmed coolant 115 may be input to the WME 130. Instead, the controller 105 may control the controlled valve 125 to direct the warmed coolant 115 to the controlled valve 145, which is controlled to direct the warmed coolant 115 to the WIHX 150.

The warmed coolant 115, assumed to be water for explanatory purposes, mixes with the ice 160 in the WIHX 150. Based on the temperature of the warmed coolant 115, some of the ice 160 may melt. The water 155 in the WIHX 150 is cooler than the warmed coolant 115 based on the heat rejection via fusion with the ice 160. This cooler water 155 is output by the WIHX 150 as the WIHX output 165. In this scenario, there is no WME output 143 (i.e., the WME 130 is bypassed). Thus, the WIHX output 165 is the input coolant 175 to the cabin air heat exchanger 110.

A scenario involving a relatively high altitude (i.e., a relatively low ambient pressure and a relatively high corresponding pressure difference) is addressed next. This scenario may occur in space, for example, where the absolute ambient pressure is about 0 psia. In this case, as Table 1 indicates, the warmed coolant 115 is input to the WME 130 and nothing is input to the WIHX 150 (i.e., the WIHX 150 is bypassed). That is, the controller 105 controls the controlled valve 125 to direct the warmed coolant 115 to the WME 130 and controls the controlled valve 145 to direct the WME output 143 to the cabin air heat exchanger 110 as the input coolant 175.

In the WME 130, the warmed coolant 115, which is assumed to be water for explanatory purposes, flows through a membrane 140. The membrane 140 is a hydrophobic membrane that passively controls the water liquid/vapor interface. At the membrane 140, water flowing through evaporates and passes out of the membrane 140 as gas 135 (i.e., water vapor in the case of the warmed coolant 115 being water). The gas 135 is vented to the external environment 138 via a vacuum vent line 137, as shown. This heat rejection via evaporation during flow through the membrane 140 results in the WME output 143 being cooler than the warmed coolant 115 that enters the WME 130.

A scenario involving an altitude and corresponding ambient pressure in between the relatively low and relatively high altitudes/ambient pressures may occur during aircraft or spacecraft flight. For example, at an altitude of 100,000 feet (ft), the ambient pressure may be sufficiently high to obtain a WME output 143 of 50 degrees Fahrenheit, the desired temperature for the input coolant 175. However, at an altitude of 90,000 ft, the ambient pressure may be such that the WME 130 provides a WME output 143 with a temperature of 60 degrees Fahrenheit. In this case, as indicated in Table 1, the WME output 143 may additionally be directed to the WIHX 150 based on the controller 105 controlling the controlled valve 145. The WME output 143 may be further cooled by the WIHX 150 such that the WIHX output 165 is provided as the input coolant 175 at the desired temperature of 50 degrees Fahrenheit.

The controller 105 may include one or more memory devices and processors to perform the control of the controlled valves 125, 145. The heat rejection from the warmed coolant 115 is based on dynamic control of the controlled valves 125, 145 by the controller 105. This dynamic control accounts for the fact that the WME 130, WIHX 150, or both are needed according to ambient pressure and the difference between the pressure of the warmed coolant 115 and the absolute ambient pressure. Because the ambient pressure and pressure difference varies with altitude, the control of the controlled valves 125, 145 may be based on altitude. The control may also be predetermined and static, following set points obtained analytically or experimentally.

The controller 105 may obtain an input of the current altitude and may use the altitude as the basis for control of the controlled valves 125, 145. Alternately or additionally, the controller 105 may obtain an input of the absolute ambient pressure and may map the pressure value to a control scheme for the controlled valves 125, 145. Alternately or additionally, the controller 105 may obtain an input of the temperature of the warmed coolant 115 at the input to the controlled valve 125 and the temperature of the WME output 143 at the input to the controlled valve 145 to determine where to direct flow through each of the controlled valves 125, 145. According to alternate embodiments, the controller 105 may implement machine learning to obtain input (e.g., altitude, absolute ambient pressure) and determine corresponding control of the controlled valves 125, 145.

TABLE 1
Inputs to WME and WIHX based on pressure difference.

| altitude/ambient pressure | input to WME | input to WIHX |
|---|---|---|
| low/high | none | warmed coolant |
| high/low | warmed coolant | none |
| in between | warmed coolant | WME output |

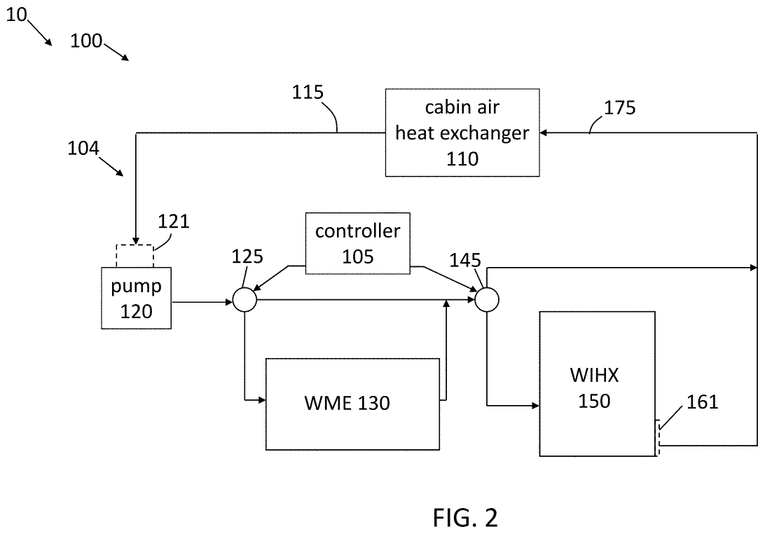

FIG. 2 is a block diagram of a heat rejection system 100 according to one or more embodiments. As FIG. 2 shows, most of the components of the coolant loop 104 are the same as those discussed with reference to FIG. 1. These components are not discussed again. Additional components include an optional gas trap 121 is shown at the inlet of the pump 120. The gas trap 121 may be used to prevent cavitation. In addition, the WIHX 150 is shown with an optional filter 161 that prevents ice from entering the coolant loop 104.

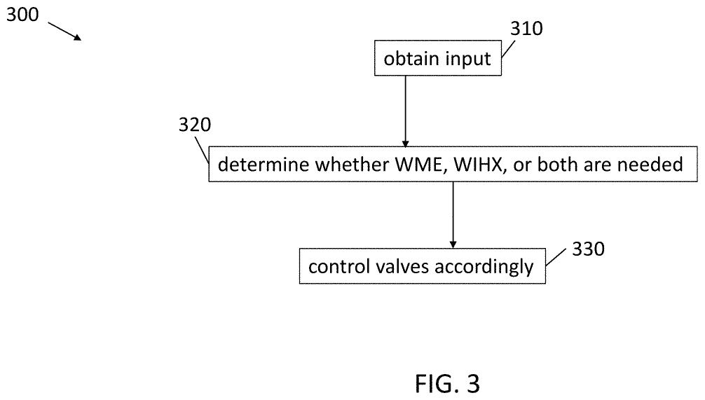

FIG. 3 is a process flow of a method 300 of performing heat rejection according to one or more embodiments. The processes may be performed by the controller 105. At block 310, obtaining input refers to obtaining altitude, ambient pressure, and/or temperature of the warmed coolant 115 and WME output 143, as previously noted. At block 320, determining whether the WME 130, WIHX 150, or both are needed may be based on a mapping (e.g., altitude or pressure difference is mapped to actions as indicated in Table 1, for example) or may be based on machine learning. At block 330, controlling the controlled valves 125, 145 is based on the determination (e.g., mapping, machine learning) at block 320.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A heat rejection system in a vehicle, the heat rejection system comprising:
a heat exchanger configured to take in input coolant and to output a warmed coolant;
a heat of vaporization device (HVD);
a heat of fusion device (HFD);
a controller configured to direct the warmed coolant to the HVD or to the HFD based on an input, wherein the input indicates altitude of the vehicle or ambient pressure.

2. The heat rejection system according to claim 1, further comprising a first valve and a second valve, wherein the controller is configured to control the first valve to direct a flow of the warmed coolant to the HVD or to the second valve and to control the second valve to direct a flow of the warmed coolant or a flow of an output of the HVD to the HFD or to direct the flow of the output of the HVD to the heat exchanger as the input coolant.

3. The heat rejection system according to claim 2, wherein the warmed coolant is water.

4. The heat rejection system according to claim 3, wherein the HVD is a water membrane evaporator (WME).

5. The heat rejection system according to claim 4, wherein the WME includes a hydrophobic membrane through which the water flows and evaporation of the water at a surface of the hydrophobic membrane results in heat rejection.

6. The heat rejection system according to claim 3, wherein the HFD is a water and ice heat exchanger (WIHX).

7. The heat rejection system according to claim 6, wherein the water interacts with ice in the WIHX and heat rejection results in melting of the ice.

8. The heat rejection system according to claim 6, further comprising a filter at an output of the WIHX to prevent ice from exiting the WIHX.

9. The heat rejection system according to claim 2, further comprising a pump disposed between the heat exchanger and the first valve.

10. The heat rejection system according to claim 1, wherein the vehicle is a spacecraft.

11. A method of assembling a heat rejection system for a vehicle, the method comprising:
arranging a heat exchanger configured to take in input coolant and to output a warmed coolant;
assembling a heat of vaporization device (HVD);
assembling a heat of fusion device (HFD); and
configuring a controller to direct the warmed coolant to the HVD or to the HFD based on an input, wherein the input indicates altitude of the vehicle or ambient pressure.

12. The method according to claim 11, further comprising arranging a first valve and a second valve, wherein the configuring the controller includes the controller controlling the first valve to direct a flow of the warmed coolant to the HVD or to the second valve and controlling the second valve to direct a flow of the warmed coolant or a flow of an output of the HVD to the HFD or to direct the flow of the output of the HVD to the heat exchanger as the input coolant.

13. The method according to claim 12, wherein the warmed coolant is water.

14. The method according to claim 13, wherein the assembling the HVD includes assembling a water membrane evaporator (WME).

15. The method according to claim 14, wherein the assembling the WME includes arranging a hydrophobic membrane through which the water flows and evaporation of the water at a surface of the hydrophobic membrane results in heat rejection.

16. The method according to claim 13, wherein the assembling the HFD includes assembling a water and ice heat exchanger (WIHX).

17. The method according to claim 16, wherein the assembling the WIHX includes filling the WIHX with ice such that water interacts with ice in the WIHX and heat rejection results in melting of the ice.

18. The method according to claim 16, further comprising arranging a filter at an output of the WIHX to prevent ice from exiting the WIHX.

19. The method according to claim 12, further comprising disposing a pump between the heat exchanger and the first valve.

20. The method according to claim 11, wherein the vehicle is a spacecraft.
